(19) United States
(12) Patent Application Publication
(10) Pub. No.: US 2006/0099130 A1
(43) Pub. Date: May 11, 2006

(54) Silica mesoporous materials

(76) Inventors: Rolando Roque-Malherbe, Las Piedras, PR (US); Francisco Marquez-Linares, San Juan, PR (US)

Correspondence Address: June E. Cohan;SHAW PITTMAN LLP, 1650 Tysons Boulevard, Mclean, VA, 22102, US

(21) Appl. No.: 10/982,798

(22) Filed: Nov. 8, 2004

(51) Int. Cl. C01B 33/12

(52) U.S. Cl. 423/335; 423/338

(57) ABSTRACT

A method for the preparation of new porous inorganic microsphere compositions possessing uniform mesopores in the range of about 200 to 450 nm. An improved process for preparing silica microspheres, and their use in synthesizing mesoporous inorganic materials. These microspheres and mesoporous materials have many applications, such as for catalyst supports, advanced ceramics, and adsorbents.

### FIELD OF THE INVENTION

The present invention relates to an improved process for preparing silica microspheres, and their use in synthesizing mesoporous inorganic materials. These microspheres and mesoporous materials have many applications, such as for catalyst supports, advanced ceramics, and adsorbents.

### BACKGROUND OF THE INVENTION

Many activities such as catalyst supports and high pressure liquid chromatography rely greatly upon porous solids of both natural and synthetic design. The pore structures of such solids are generally formed during crystallization or during subsequent treatments. Porous solids may be formed from porous particles or materials, or may have a porous nature due to interstitial pores, i.e., pores between individual particles in an aggregate. These solid materials are classified depending upon their predominant pore sizes: pore sizes <1.0 nm are classified as microporous; pore sizes exceeding 50.0 nm are macroporous; and pore sizes intermediate between 1.0 and 50.0 nm are mesoporous. Macroporous solid materials find limited use as adsorbents or catalysts owing to their low surface areas and large non-uniform pores. Microporous and mesoporous solids, however, are widely utilized in adsorption, separation technologies and catalysis.

Porous materials may be structurally amorphous, para-crystalline or crystalline.

Amorphous materials, such as silica gel or alumina gel, do not possess long range crystallographic order, whereas para-crystalline solids such as γ-alumina or η-alumina are semi-ordered, produce broad X-ray diffraction peaks. Although both silica and alumina gels exhibit desirable pore sizes in the mesoporous range, their utility is limited due to their broad pore size distributions (i.e., the pore size is not uniform). Because of these broad pore size distributions, the effectiveness of these materials as catalysts, adsorbents and ion-exchange systems is limited.

Zeolites and some related molecular sieves, such as alumino-phosphates and pillar interlayered clays, possess more uniform pore sizes. Zeolites are highly crystalline microporous aluminosilicates where the lattice of the material is composed of IO₄ tetrahedra (I═Al, Si) linked by sharing the apical oxygen atoms. Cavities and connecting channels, of uniform size, form the pore structures that are confined within the specially oriented IO₄ tetrahedra. Most of the known zeolites and molecular sieve frameworks, however, only exhibit uniform pore sizes when the pore sizes are in the microporous range. As pore sizes increase, the pore size distribution becomes non-uniform.

In the 1990s, researchers of the Mobil Oil Corporation developed a new family of ordered mesoporous silica, called Mesoporous Molecular Sieves (MMS). C. T. Kresge et al., Nature 359:710 (1992); J. S. Beck et al., J. Amer. Chem. Soc. 114:10834 (1992); X. S. Zhao et al., Ind. Eng. Chem. Res. 35:2075 (1996). These MMS are synthesized by using surfactant liquid crystals with long n-alkyl chains as structure-directing agents. By applying this methodology, a family of mesostructured materials including MCM-41 (hexagonal phase), MCM-48 (cubic phase), and MCM-50 (lamellar phase), were developed. The mesoporous nature of these materials, however, is due to the interstitial pore size, i.e., the size of the pores between individual particles in an aggregate, and not to the particles themselves being porous.

Silica, and particularly porous silica, has been the subject of intensive research since the discovery of silica sols and gels in the 1920s, and the invention of pyrogenic silica in the 1940s. Silica may occur in porous forms or non-porous forms. Non-porous forms include mineral opals and pyrogenic silica, which is obtained by vaporizing SiO₂ in an arc or a plasma jet, or by the oxidation of silicon compounds. M. A. Hernandez et al., Energy & Fuels 17:262 (2003); G. M. S. El Shaffey, in Adsorption on Silica Surfaces, Surfactant Science Series (E. Papirer, ed.) 90:35-62 (2000).

Porous forms of silica include amorphous silica and synthetic opals. Amorphous silica is obtained by acidification of basic aqueous silicate solutions or reaction of alkoxides with water. T. J. Barton et al., Chem. Mater. 11:2633 (1999). Synthetic opals may be produced from silica microspheres that are periodically arranged, forming close-packed structures. E. Yablonobitch, Phys. Rev. Lett. 58:2059 (1987); F. Messeguer et al., Recent Res. Devel. App. Phy. 2:327 (1999); S. M. Yang et al., Adv. Funct. Mater. 11:425 (2002); H. Miguez, Artificial Opals as Photonic Crystals, Ph.D. Thesis from Universidad Autonoma of Madrid (1999); Garcia-Santamaria et al., ______ 18:1942 (2002). Artificial opals are colloidal “crystals” that are dielectrics, with periodic structures in which the refractive index varies in three dimensions.

Silicon microspheres can be further processed to form artificial opals, photonic crystals, and other useful synthetic compounds. These microspheres themselves have found only limited application as catalysts, catalyst supports or adsorbents, however, because the mesoporosity of these materials is related to the interstitial pore space in particle aggregates, and not with the porosity of the microspheres, which are considered to have a very low surface porosity. T. J. Barton et al., Chem. Mater. 11:2633 (1999); Garcia-Santamaria et al., ______ 18:1942 (2002); A. J. Lecloux et al., J. Colloids and Surfaces 19:359 (1986).

Therefore, there remains a need for silica microspheres having uniform pore sizes in the mesoporous range, wherein the microspheres themselves are mesoporous.

### SUMMARY OF THE INVENTION

The present invention provides mesoporous silica microspheres of substantially uniform size characterized in having a mean diameter of less than about 200 nm, and a surface porosity greater than about 450 m²/g. Also provided are methods of making such mesoporous silica microspheres, consisting essentially of preparing a solution of a basic catalyst in low molecular weight alcohol at ambient temperature, adding a silicon alkoxide to the solution to form a mixed solution, aging the mixed solution with agitation at ambient temperature to form a crystallized product, and heating the crystallized product to about 70° C. for about 20 hours to form mesoporous silica microspheres.

The present invention further provides mesoporous silica microspheres of substantially uniform size characterized in having a mean diameter in the range of about 200 to about 450 nm, and a porosity in the range of about 300 to about 625 m²/g. Also provided are methods of making such mesoporous silica microspheres, consisting essentially of preparing a solution of a basic catalyst in low molecular weight alcohol at about 25° C., adding a silicon alkoxide and water to the solution to form a mixed solution, aging the mixed solution with agitation at about 25° C. to form a crystallized product, and heating the crystallized product to about 70° C. for about 20 hours to form porous silica microspheres.

Additional advantages and features of the present invention will be apparent from the following drawings, detailed description and examples which illustrate preferred embodiments of the invention.

### BRIEF DESCRIPTION OF THE DRAWINGS

FIG. 1 is an SEM micrograph illustrating the microspheric structure of microsphere sample 81C of the present invention (the bar is 1500 nm long).

FIG. 2 is an SEM micrograph illustrating the microspheric structure of microsphere sample 80 of the present invention (the bar is 1500 nm long).

FIG. 3 is an SEM micrograph illustrating the microspheric structure of microsphere sample 68C of the present invention (the bar is 1500 nm long).

FIG. 4 is an SEM micrograph illustrating the microspheric structure of microsphere sample 68F of the present invention (the bar is 200 nm long).

FIG. 5 depicts an adsorption isotherm of N₂ in microsphere sample 68F of the present invention (♦: adsorption branch, ▪: desorption branch).

FIG. 6 depicts an adsorption isotherm of N₂ in microsphere sample 69B of the present invention (♦: adsorption branch, ▪: desorption branch).

FIG. 7 depicts an adsorption isotherm of N₂ in microsphere sample 80 of the present invention (♦: adsorption branch, ▪: desorption branch).

FIG. 8 depicts an adsorption isotherm of N₂ in microsphere sample 81C of the present invention (♦: adsorption branch, ▪: desorption branch).

FIG. 9 depicts an adsorption isotherm of N₂ in an MCM-41 standard (♦: adsorption branch, ▪: desorption branch).

FIG. 10 depicts the DFT-PSD of microsphere sample 68F of the present invention.

FIG. 11 depicts the DFT-PSD of microsphere sample 80 of the present invention.

FIG. 12 depicts the DFT-PSD of microsphere sample 81C of the present invention.

FIG. 13 depicts the DFT-PSD of an MCM-41 standard.

### DETAILED DESCRIPTION OF THE INVENTION

Reference will now be made in detail to the presently preferred embodiments of the invention, which, together with the following examples, serve to explain the principles of the invention. These embodiments are described in sufficient detail to enable those skilled in the art to practice the invention, and it is to be understood that other embodiments may be utilized, and that structural, chemical, and biological changes may be made without departing from the spirit and scope of the present invention.

The present invention relates to a process for preparing silica microspheres, and to mesoporous silica microspheres produced by such a process. These microspheres have many applications, such as for catalyst supports, advanced ceramics, materials for ultrafiltration membrane synthesis, and adsorbents. The process is a modification of the well-known Stöber-Fink-Bohn (SFB) process described in W. Stöber et al., J. Colloid Interface Sci. 26:62 (1968).

The general method of carrying out the silica sphere-forming process of the present invention is described as follows. Although the reaction is a two-step process, generally it is carried out in a single reaction vessel and the reactants are added at the same time, although the steps can be carried out separately. This process involves a reaction having two steps: (1) hydrolysis of a silicon alkoxide:
Si(OR)₄+H₂O→(OR)₃Si(OH)+ROH (1)
followed by (2) condensation of the hydrolyzed species in basic medium:
(RO₃)Si(OH)+H₂O→SiO₂↓3ROH (2)
Careful selection of reactants, reactant concentrations, and reactant conditions allows for the production of silica particles (microspheres) with controlled dimensions and having uniform pore sizes.

The sphere-forming process is generally carried out by adding to a reaction vessel the following reactants: first, a basic catalyst, in a solvent of low molecular weight alcohol, and the optional addition of water, all of these being mixed with strong agitation; and second, a silicon alkoxide. Once the reactants have been added, the reaction vessel is then subjected to the following reaction conditions. The reaction may be carried out at any temperature within the range of 4 and 70 degrees Celsius, but is preferably carried out within the range of 20 to 70 degrees Celsius, and more preferably within the range of 18 to 25 degrees Celsius. As the temperature is increased, the sphere size is reduced, and so the temperature may be modified to affect the desired reaction yield. The reaction is allowed to proceed for sufficient time to produce a favorable yield of crystallized product, generally within the range of 1.5 to 2 hours. During this time, the reaction vessel is agitated such as by stirring, sonication, or shaking. After crystallization has occurred, the product is heated to about 70 degrees Celsius for about 20 hours.

Double-distilled water (DDW) may be added to the reaction to provide a particular concentration, or the water content of those reactants in aqueous solution may be taken into account in producing the desired end concentration of water. Generally, water serves as the hydrolytic agent in the first step of the reaction, and also, in combination with the basic catalyst, affects the size of the spheres formed in the second (condensing) step of the reaction. In the present process, microspheres of particularly small diameter may be achieved if water is virtually eliminated from the reactants.

The basic catalyst should be used at a concentration resulting in the reaction mixture having a pH between 7 and 11, to avoid aggregation and sol-gel formation. The basic catalyst serves as a morphological catalyst to the reaction, in that its presence causes the reaction to yield non-soluble spheres of silica, whereas in its absence the reaction yields irregularly shaped flocculating particles, sol-gels, or other non-spherical forms of silica. Suitable catalysts include, but are not limited to, ammonia (ammonium hydroxide), short-chain alkylamines (such as triethylamine, propylamine, etc.), or mixtures of short-chain alkylamines with sodium hydroxide in aqueous solution. Generally, if a larger sphere diameter is desired, a stronger base should be used, such as ammonium hydroxide or sodium hydroxide. The basic catalyst may be used at any suitable concentration, and in a preferred embodiment is used at a concentration in the approximate range of 0.1 M to 3.0 M.

The alcohols preferred for use are low molecular weight alcohols, and include, but are not limited to, methanol, ethanol, propanol (n- and iso-), butanol (n-, sec-, and tert-), and mixtures thereof. Generally, with smaller alcohols the reaction rates are faster, and the final sphere diameter is smaller. If a larger sphere diameter is desired, then a larger alcohol such as butanol may be used, however a mixture of alcohols may be more desirable because the sphere size distribution is more uniform. Preferred alcohols include, but are not limited to, methanol and isopropanol, and preferred alcohol mixtures include, but are not limited to, 1:1 methanol/ethanol, 1:1 methanol/butanol, and 1:3 methanol/n-propanol.

The silicon alkoxide reactants include, but are not limited to, tetraesters of silicic acid, e.g., tetramethyl orthosilicate (also known as silicon methoxide or methyl silicate), tetraethyl orthosilicate (TEOS) (also known as silicon ethoxide or ethyl silicate), tetrapropyl orthosilicate (also known as silicon propoxide), tetrabutyl orthosilicate (also known as silicon butoxide), tetrahexyl orthosilicate (also known as silicon hexoxide), and mixtures thereof. Smaller alkoxides generally react faster and yield a smaller diameter sphere than the larger alkoxides. For production of spheres smaller than about 600 nm, use of a smaller silicon alkoxide such as TEOS is generally preferred. The silicon alkoxide reactant may be used at any suitable concentration, and in a preferred embodiment is used at a concentration in the approximate range of 0.1 M to 0.5 M.

The sphere-forming process described above produces silica spheres, which generally have diameters between about 200 to 450 nm, with a narrow size distribution. When the spheres are dried as dry powders they are often called opal powders. These silica spheres and opal powders have uses in a wide variety of industrial and consumer products, including abrasives, dentifrices, moisture scavengers in paints and coatings, stabilizers, coatings, glazes, emulsifiers, strengtheners and binders.

Application of the teachings of the present invention to a specific problem or environment is within the capabilities of one having ordinary skill in the art in light of the teachings contained herein. Examples of the products and processes of the present invention appear in the following examples.

### EXAMPLE 1

Scanning Electron Microscope (SEM) Protocol

SEM studies were carried out with a JEOL Model 5800LV scanning electron microscope. The acceleration of the electron beam was 20 kV. The sample grains were glued with silver colloid to the sample-holder and were coated at vacuum by cathode sputtering with a 30-40 nm gold film prior to observation, using the method reported in G. Rodriguez et al., Zeolites, in Synthesis, Structure, Technology and Applications, Studies in Surface Science and Catalysis (B. Drzaj et al., eds.) 24:275-285 (1985). The X-ray diffractograms were obtained in a Siemens D5000 X-ray Diffractometer, in vertical set up, with Cu—Kₐ radiation source, Ni filter and Graphite monochromator.

Measurement of the specific surface area (S [m²/g]), micropore volume (W^{MP} [cm³/g]), pore volume (W [cm³/g]) and pore size distribution (PSD) of samples was made by analyzing isotherms of physical adsorption of gases and vapors, such as the Dubinin adsorption isotherm, M. M. Dubinin, Prog. Surf. Memb. Sci. 9:1 (1975); the t-plot method, F. Rouquerol et al., Adsorption by Powder Porous Solids (Academic Press 1999); and other isotherms, R. Roque-Malherbe, Mic. Mes. Mat. 41:227 (2000).

PSD was calculated using a new methodology of adsorption isotherm calculation based on the Non-Local Density Function Theory which originated in the Density Functional Theory (DFT) applied to inhomogeneous fluids. See, e.g., A. V. Neimark et al., Mic. Mes. Mat. 44-45:697 (2001); P. I. Ravikovitch et al., Colloids & Surfaces A 11:187-188 (2001); A. V. Neimark et al., Phys. Condens. Matter 15:347 (2003); R. Evans, in Fundamentals of Inhomogeneous Fluids (D. Henderson ed.) 85-175 (1992). This new methodology is implemented in the Quantachrome Autosorb-1 Analyzer used in the present studies to measure the adsorption isotherms of N₂ at 77 K in different microsphere samples and in a MCM-41 mesoporous material used for testing purposes. PSD measured by this methodology is referred to as DFT-PSD. Prior to measurement, the samples were degassed at 200 degrees Celsius for 3 hours in high vacuum (10⁻⁶ Torr).

S was measured using the BET and t-plot methods. K. S. W. Sing et al., Pure App. Chem. 57:603 (1985); F. Rouquerol et al., Adsorption by Powder Porous Solids (Academic Press 1999). W^{MP} was measured using the Dubinin adsorption isotherm. M. M. Dubinin, Prog. Surf Memb. Sci. 9:1 (1975). The DFT method with a nitrogen-silica DFT kernel was used to get the DFT-PSD in the range between 1.8-100 nm and the DFT-pore volume (W [cm³/g]) which is the sum of the micropore (pore width less than 20 Å) and mesopore (pore widths in the range between 20-500 Å) volumes of the sample. This complete methodology is implemented in the Autosorb-1 Analyzer from Quantachrome Instruments (Boynton Beach, Fla.).

### EXAMPLE 2

Silica Sphere Synthesis

Silica spheres were prepared by hydrolysis and condensation of TEOS in methanol or isopropanol with ammonia (NH₃) as the basic catalyst. Reagent grade ammonium hydroxide (30 wt % NH₃), methanol, isopropanol, and TEOS (99% purity) were purchased from standard laboratory suppliers. Deionized 18 MΩ water was produced by a filtering system. MCM-41 was synthesized using the methods of X S Zhao et al., Ind. Eng. Chem. Res. 35:2075 (1996) and J. S. Beck et al., J. Amer. Chem. Soc. 114:10834 (1992).

Concentrations were calculated using the following densities (p) and molecular weights (MWs): TEOS (ρ=0.93 g/cm³, MW=208.3 g/mol); methanol (ρ=0.79 g/cm³, MW=32.04 g/mol); ethanol (ρ=0.78 g/cm³, MW=46.07 g/mol); water (MW=18 g/mol); ammonia (ρ=0.89 g/cm³ (30 wt % NH₃), MW=17 g/mol); SiO₂ (ρ=1.9 g/cm³, MW=60.08 g/mol).

Equal volumes of TEOS-alcohol solution and water-ammonia-alcohol solution were mixed in a clean flask. Reagent concentrations were as shown below in Table 1.

TABLE 1

| | TEOS | DDW | MeOH | Isoprop | NH₄OH |
|---|---|---|---|---|---|
| Sample | [ml] | [ml] | [ml] | [ml] | [ml] |
| 10 | 1.5 | 0.6 | 0 | 30 | 6.0 |
| 68B | 1.5 | 0.3 | 0 | 30 | 6.0 |
| 68C | 1.5 | 4.5 | 30 | 0 | 6.0 |
| 68E | 2.4 | 0 | 30 | 0 | 6.0 |
| 68F | 0.75 | 0 | 30 | 0 | 3.0 |
| 69B | 1.5 | 0.6 | 0 | 30 | 6.0 |
| 80 | 1.5 | 0 | 30 | 0 | 6.0 |
| 81C | 1.5 | 8.4 | 30 | 0 | 6.0 |

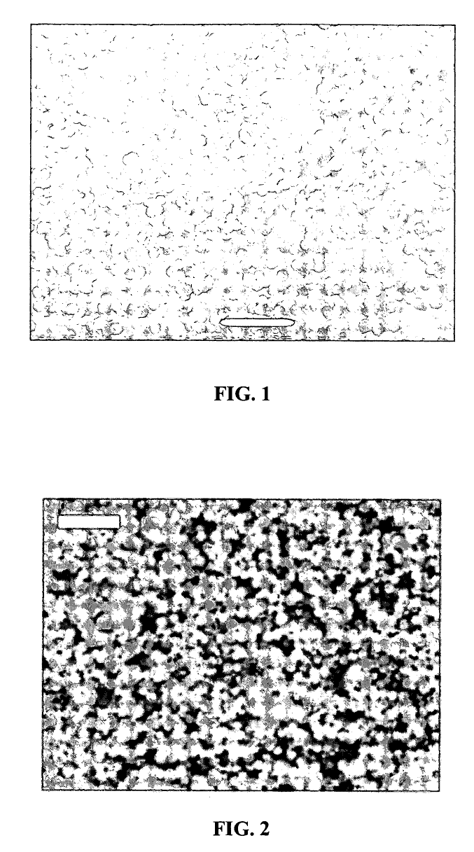

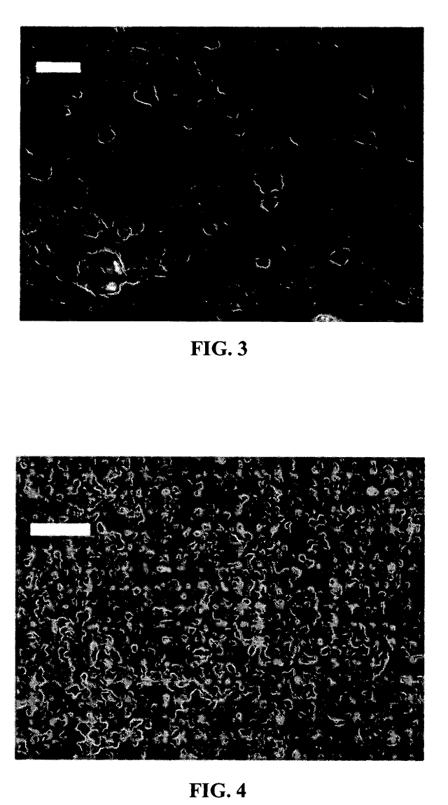

The resultant microsphere powders were studied using SEM according to the methods described in Example 1, which revealed that the powders are formed of microspheres. FIGS. 1, 2, 3, and 4 are SEM micrographs illustrating the microspheric structure of samples 81C, 80, 68C, and 68F, respectively. The calculated average particle diameters, as determined by SEM (DSEM), of several samples are shown below in Table 2.

TABLE 2

| Sample | D_{SEM} [nm] |
|---|---|
| 80 | 200 ± 25 |
| 81C | 225 ± 25 |
| 68C | 275 ± 25 |
| 10 | 375 ± 25 |
| 68E | 450 ± 50 |

### EXAMPLE 3

Analysis of Samples

The BET-specific surface area (S), DFT-pore volume (W) and the mode of the DFT-pore width (d) of the sample powders were calculated according to the methods described in Example 1, and the results are shown below in Table 3, along with the values for MCM-41. The data show that the specific surface area (S) of some of the obtained microsphere samples is about one-half of the specific surface area (S) and one-third of the pore volume (W) of the MCM-41 sample used as standard, besides they have very similar pore width.

TABLE 3

| Sample | S [m²/g] | W [cm³/g] | d [nm] |
|---|---|---|---|
| 68C | 320 | 0.46 | 2.1 |
| 68E | 18 | 0.04 | 6.1 |
| 68F | 625 | 1.18 | 8.1 |
| 69B | 300 | 0.52 | 3.5 |
| 80 | 440 | 0.49 | 3.9 |
| 81C | 438 | 0.58 | 3.5 |
| MCM-41 | 820 | 1.69 | 3.5 |

A simple calculation of the theoretical specific surface area of the microsphere powder (S_{T}, [m²/g]) considering that the spheres possess smooth surfaces, allows us to show that S_{T}=(6/Dρ). Knowing that the opal density is: 2.1 g/cm³, and using the data in Table 2, the obtained specific surface area should correspond to particles of a few nanometers in diameter, however, the particles are a few hundreds of nanometers in diameter (see Table 2). To explain this disagreement, the obtained DFT-PSD values indicate the existence of a PSD with mode values in the order of some nm (see Table 3), meaning that the microspheres have pores of a width in the mesoporous range, and do not have a smooth surface.

This result is very surprising, because silica microspheres produced by the SFB method are nonporous materials. See M. H. Garcia-Santamaria et al., ______ 18:1942 (2002). These mesoporous silica microspheres are a great improvement over known mesoporous materials, because opals are very stable materials in contrast with MCM-41 which is an extremely unstable material.

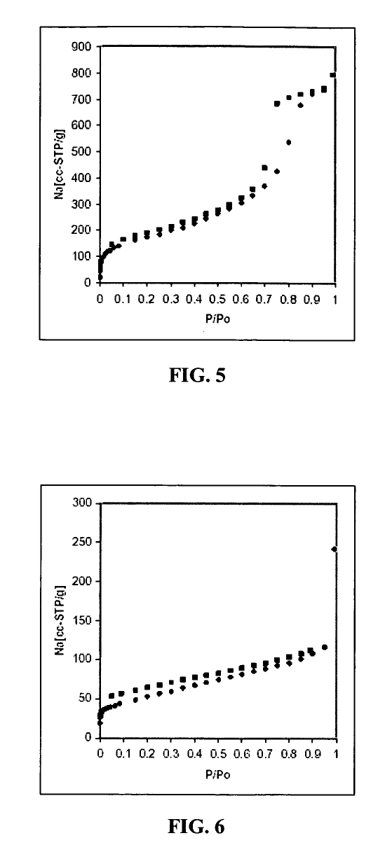

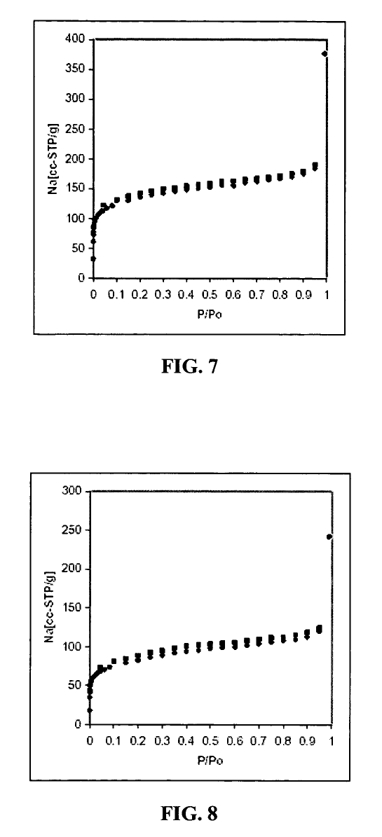

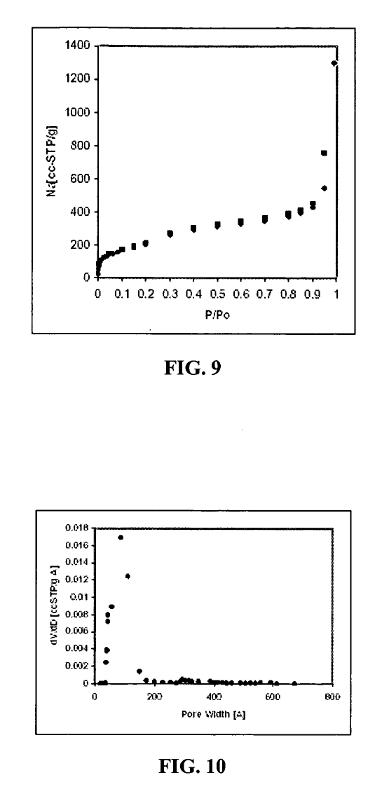

FIGS. 5 through 9 depict adsorption isotherms of N₂ at 77 K for several microsphere samples (samples 68F, 69B, 80, and 81C, in FIGS. 5, 6, 7, and 8, respectively) as compared to a standard (MCM-41; FIG. 9). As previously stated in Example 1, the gas adsorption method is suitable for obtaining the micropore volume (W^{MP}) and the specific surface area (S), which in the present study were calculated using the Dubinin adsorption isotherm and the BET methods respectively. The beginning of the adsorption isotherm is used for this purpose, that is: 0.00001<P/Po<0.02 for the Dubinin plot and 0.05<P/Po<0.3, for the BET plot. In Table 3 is reported the specific surface area (S) of some of the synthesized microsphere samples and the MCM-41 sample used as a standard. The result obtained for the micropore volume measured with the help of the Dubinin equation was negligible, consequently the microspheres do not exhibit a micropore structure, that is pores with diameter less than about 2 nm.

In the S-shaped segment of the adsorption isotherm, the pores in the mesoporous range (between approximately 2-50 nm) fill with liquid N₂, due to a process named capillary condensation. Capillary condensation is normally related with hysteresis, that is condensation and evaporation of the confined liquid N₂ occurs at different pressures, fact which is evidenced in the isotherms (FIGS. 5-9). Hysteresis can be understood as an inherent property of the sorption and phase behavior of fluids confined to small pores, wherein the pressure at which pore condensation/evaporation occurs depends on the pore width. The smaller the pore diameter, the lesser the relative pressure (P/Po) at which pore condensation take place, therefore small pores are filled first with liquid N₂, and then as the pressure increases bigger pores are also filled.

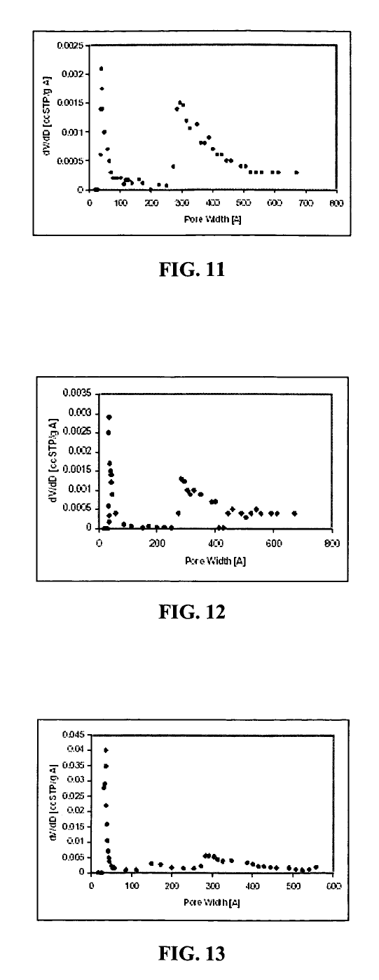

FIGS. 10 through 13 depict DFT-PSD corresponding to samples 68F, 80, and 81C, as compared to a standard MCM-41, respectively. Evidence of two kinds of porosities can be seen: a porosity in the range of several nm, which is associated with the pores in the sphere itself, and a porosity in the range of several tenths of nm, which is associated with the interstitial pore space in particle aggregates.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art, and the scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be and still remain within the spirit and scope of the present invention.

All of the patents, publications and references mentioned herein are incorporated by reference in their entirety.

1. Mesoporous silica microspheres of substantially uniform size characterized in having a mean diameter of less than about 200 nm, and a surface porosity greater than about 450 m²/g.

2. The microspheres of claim 1, of which at least 80% are within ±20% of the average diameter.

3. The microspheres of claim 1, of which at least 90% are within ±15% of the average diameter.

4. The microspheres of claim 1, further characterized by having a pore volume greater than about 0.4 cm³/g.

5. The microspheres of claim 1, further characterized by having a pore volume greater than about 1.2 cm³/g.

6. A method of making the mesoporous silica microspheres of claim 1, consisting essentially of:
preparing a solution of a basic catalyst in low molecular weight alcohol at ambient temperature;
adding a silicon alkoxide to said solution to form a mixed solution;
aging said mixed solution with agitation at ambient temperature to form a crystallized product; and
heating said crystallized product to about 70° C. for about 20 hours to form mesoporous silica microspheres.

7. The method of claim 6, wherein the basic catalyst is ammonium hydroxide.

8. The method of claim 6, wherein the basic catalyst comprises sodium hydroxide and one or more short-chain alkylamines.

9. The method of claim 6, wherein the low molecular weight alcohol is selected from the group consisting of methanol, ethanol, propanol, butanol, and mixtures thereof.

10. The method of claim 6, wherein the low molecular weight alcohol is a 1:1 mixture of methanol and isopropanol.

11. The method of claim 6, wherein the ambient temperature is about 18° C. to about 25° C.

12. The method of claim 6, wherein the silicon alkoxide is tetraethyl orthosilicate.

13. The method of claim 6, wherein the silicon alkoxide comprises a plurality of silicon alkoxides selected from the group consisting of tetramethyl orthosilicate, tetraethyl orthosilicate, tetrapropyl orthosilicate, and tetrabutyl orthosilicate.

14. The method of claim 6, wherein said aging step is conducted for about 1 to about 3 hours.

15. The method of claim 6, wherein said aging step is conducted for about 1.5 to about 2 hours.

16. Mesoporous silica microspheres of substantially uniform size characterized in having a mean diameter in the range of about 200 to about 450 nm, and a porosity in the range of about 300 to about 625 m²/g.

17. The microspheres of claim 16, of which at least 80% are within ±20% of the average diameter.

18. The microspheres of claim 16, of which at least 90% are within ±15% of the average diameter.

19. A method of making the mesoporous silica microspheres of claim 16, consisting essentially of:
preparing a solution of a basic catalyst in low molecular weight alcohol at about 25° C.;
adding a silicon alkoxide and water to said solution to form a mixed solution;
aging said mixed solution with agitation at about 25° C. to form a crystallized product; and
heating said crystallized product to about 70° C. for about 20 hours to form porous silica microspheres.

20. The method of claim 19, wherein the basic catalyst is ammonium hydroxide.

21. The method of claim 19, wherein the basic catalyst comprises sodium hydroxide and one or more short-chain alkylamines.

22. The method of claim 19, wherein the low molecular weight alcohol is methanol.

23. The method of claim 19, wherein the low molecular weight alcohol is isopropanol.

24. The method of claim 19, wherein the low molecular weight alcohol is a 1:1 mixture of methanol and isopropanol.

25. The method of claim 19, wherein the silicon alkoxide is tetraethyl orthosilicate.

26. The method of claim 19, wherein the silicon alkoxide comprises a plurality of silicon alkoxides selected from the group consisting of tetramethyl orthosilicate, tetraethyl orthosilicate, tetrapropyl orthosilicate, and tetrabutyl orthosilicate.

27. The method of claim 19, wherein said aging step is conducted for about 1 to about 3 hours.

28. The method of claim 19, wherein said aging step is conducted for about 1.5 to about 2 hours.
